(19) United States
(12) Patent Application Publication
(10) Pub. No.: US 2007/0159322 A1
(43) Pub. Date: Jul. 12, 2007

(54) Location, tracking and alerting apparatus and method

(76) Inventor: Thomas Robert Garratt Campbell, London (GB)

Correspondence Address: DRUMMOND & DUCKWORTH;Suite 500, 4590 MacArthur Blvd.,, Newport Beach, CA, 92660, US

(21) Appl. No.: 11/588,571

(22) Filed: Oct. 27, 2006

(30) Foreign Application Priority Data
Oct. 29, 2005 (GB) GB 0522078.5

(51) Int. Cl. G08B 1/08; G08B 23/00; H04Q 7/20

(52) U.S. Cl. 340/539.13; 340/573.4; 455/456.1

(57) ABSTRACT

This invention describes a product that is used during emergency incidents where the location of people can be used to track who could have been involved in the incident for example Industrial Accidents, Extreme Weather, Natural Disasters, Terrorist Attacks etc. The service locates people using devices they carry with them typically their mobile phone (1). The people's locations are compared to the location and radius of the incident and the probability that they may have been involved in the incident is determined (possible or low probability). People are also automatically contacted by a verity of means for example SMS (2) to their mobile and asked to confirm their status. Their status is automatically updated and available to people who they have linked themselves to via the service.

### BACKGROUND OF THE INVENTION

This invention relates to a method and apparatus for locating and tracking a user of a mobile terminal during periods of emergency and for alerting friends, family and other contacts of that user of the status of that user.

In the event of sudden emergencies arising such as terrorist incidents, major industrial accidents or natural disasters, people naturally need to be reassured that their friends and family are safe. That is, either that they are not near the site of the emergency or that, if they are in the vicinity, that they are accounted for and safe.

Most people carry or have access to mobile communications devices, such as mobile phones (cell phones), network PDAs and so on and these can be used to inform the contacts of the mobile user that the user is safe. However, in the event of major incidents, telecommunication networks often become overloaded. Thus, if a user finds himself in the vicinity of an emergency situation or may be a short distance outside it, he is often not able to inform his friends and family immediately that he is safe. Even if he is, he needs to call each separate contact individually and this also adds to the problem of congestion of the telecommunications networks.

The present invention arose in an attempt to provide an improved method for locating and tracking user's of mobile terminals and for alerting their contacts with their status details.

### SUMMARY OF THE INVENTION

According to the present invention in a first aspect there is provided a method of determining the status of holders of mobile communications terminals during an incident, comprising determining the location of an incident; determining the position of the mobile terminal and using the position of the mobile terminal relative to the incident to determine the state of the user of that terminal, and using that status to transmit a message concerning the user's status to one or more selected contacts of that user.

Preferably, the method includes a step of determining whether the terminal is within a predetermined distance from the epicentre of the incident or of the incident or not and sending an appropriate status message to the one or more contacts accordingly.

The method preferably includes, if the terminal is within a predetermined distance from the incident, of transmitting a message to the terminal requesting a response so that the status transmitted can be based upon this response.

In a further aspect, the invention provides a system for locating the user of a mobile terminal in the event of an incident and alerting one or more predetermined contacts, the system comprising, in the event of a particular incident, determining the position of the mobile terminal and its relative distance from the incident or the epicentre of an incident, and means for using this position to transmit status messages to one or more predetermined contacts.

Preferably, the system comprises means for determining whether the terminal is within a predetermined distance from the incident or incident epicentre and, if so, for transmitting a message to the terminal requiring a response so that the presence or absence of a response determines the status transmitted to said one or more contacts.

The system may comprise means for determining whether the terminal is greater than a predetermined distance from the incident or epicentre and, if so, for transmitting a signal to one or more contacts regarding the status of the terminal user.

Further, non-limiting features of the invention which are considered inventive in their own right are the following:

a) An emergency location and alerting service that locates people and groups of people when an emergency incident occurs, determining their status via the their distance from incident.

b) An emergency location and alerting service as in that also determines a persons likelihood of people be affected by the incident using their location accuracy information.

c) An emergency location and alerting service as in a) that also contact people via a messaging system to determine their if they were involved in the incident.

d) An emergency location and alerting service as in a) that also determines a persons likelihood of being affected by the incident using this reply to a status request message.

e) An emergency location and alerting service as in a) that also allows people to select groups of other people to be monitored.

f) An emergency location and alerting service as in a) that also give status information to members of a group about other members of the group.

g) An emergency location and alerting service as in a) where locations of the people can be delivered in bulk from the mobile operators rather than one at a time on request.

h) An emergency location and alerting service as in a) were the incidents may have multiple locations that can be can be tracked and reported either together or separately.

i) An emergency location and alerting service as in a) where when a person adds an individual to their group they are also added to that persons group.

j) An emergency location and alerting service as in a) where when a person adds an individual to their group they are not added to that persons group.

k) An emergency location and alerting service as in a) where information on the incident is sent to all people in the system.

l) An emergency location and alerting service as in a) where information on the incident is sent to selected people in the system.

The invention also extends to any novel feature or novel combination of features herein disclosed.

### BRIEF DESCRIPTION OF THE DRAWINGS

Embodiments of the invention will now be described, by way of example only, with reference to the accompanying drawings, in which:

FIG. 1 shows an incident location and alerting system;

FIG. 2 shows schematic the location of an incident and relative locations of users;

FIG. 3 shows the parameters used to calculate the distance of a user from the incident;

FIG. 4 shows the categorisation of person based on their distance; and

FIG. 5 shows a message sent to users of different status.

### DETAILED DESCRIPTION OF THE INVENTION

Essentially, the invention relates to a method of effectively locating a mobile terminal (and therefore the user of the mobile terminal) during an emergency or other incident and of being able to establish whether the user, based upon his position relative to the incident, is likely to be safe or not. If he is a sufficient distance from the incident or the incident's epicentre then a message is sent to a number of predetermined contacts or other users in a group in effect stating that that user is OK. That is, he is a sufficiently safe distance away from the incident that he is unaffected by it. If the user is determined to be less than a predetermined distance from the incident epicentre, then the user may or may not be safe. In this instance, the invention may provide that a message is automatically sent to the user's mobile terminal requesting a response. If the user responds with a response, perhaps a predefined message such as ‘I'm OK’ or similar, then the system is also arranged to send an appropriate message to that user's predetermined contacts indicating that despite his proximity to the incident he has confirmed that he is safe.

The invention creates a way of effectively knowing the status of friends, colleagues and family members during an emergency incident. Each person can be located just once using LBS (location based services) and are preferably just once or if necessary more than once asked if they are OK using a messaging service. This information can then be used multiple times by all people who are associated with that person. This highly streamlined communication leads to fast and efficient feedback of everyone's status to all interested parties. With previously proposed systems, each individual colleague, family member or other contact must contact the user individually to try to determine his status.

A person can use a number of methods to sign up for the service and interact (for example: web, mobile, messaging, IVR, call centre). They can then use any of these methods to manage a group or groups of people that they are interested in knowing the status of during and emergency incident.

During an incident, the incident details are first been entered into the system. The system will use any one of a number of technologies to both locate appropriate users. These methods could be for example: personal GPRS based devices, PDAs or smart cell phones equipped with GPS (global positioning service) receivers or other satellite positioning systems. Cell phone infrastructure configured to report the location of its customers cell phone to selected organisations and companies. Or other location determining methods or technologies.

The system will also contact people via one or more messaging service to confirm or determine their status. This can be prioritised based on their location and distance from the incident. The messaging can be for example: email, instant messaging, mobile instance messaging, SMS (short message service), MMS, paging, outgoing IVR, or other communication service or technology.

Based on the location and the response the product receives from the messages the persons status is determined and summarised and detailed information on each persons group is returned to each group member and or group owner.

Further status information can be requested via the messaging channel.

The product is designed to only give information it has received and not generate false positives or negatives.

The product has built in automatic testing procedures that are continually using all sub components and report their status.

The product uses standard techniques and mapping references to locate and track incidents and people the distance a person is from an incident may calculated using the simple equation D=√( A²+B²) see FIG. 3, or otherwise.

The product allows fast and accurate dissemination of information regarding the incident to key people and the general population.

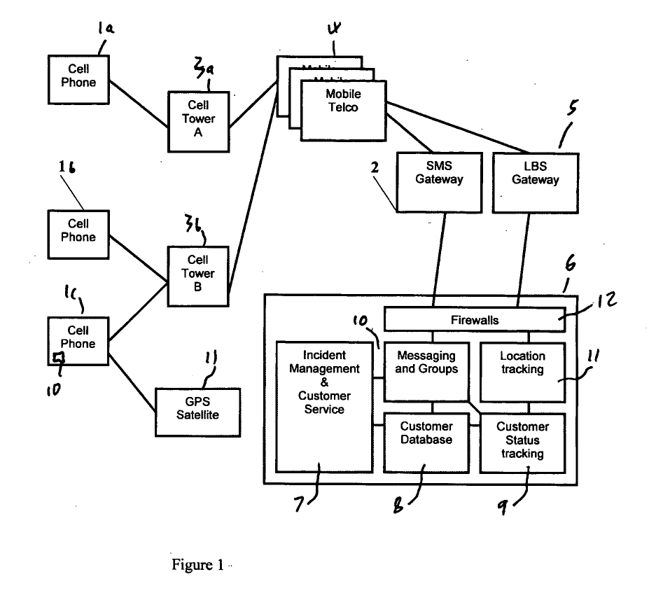

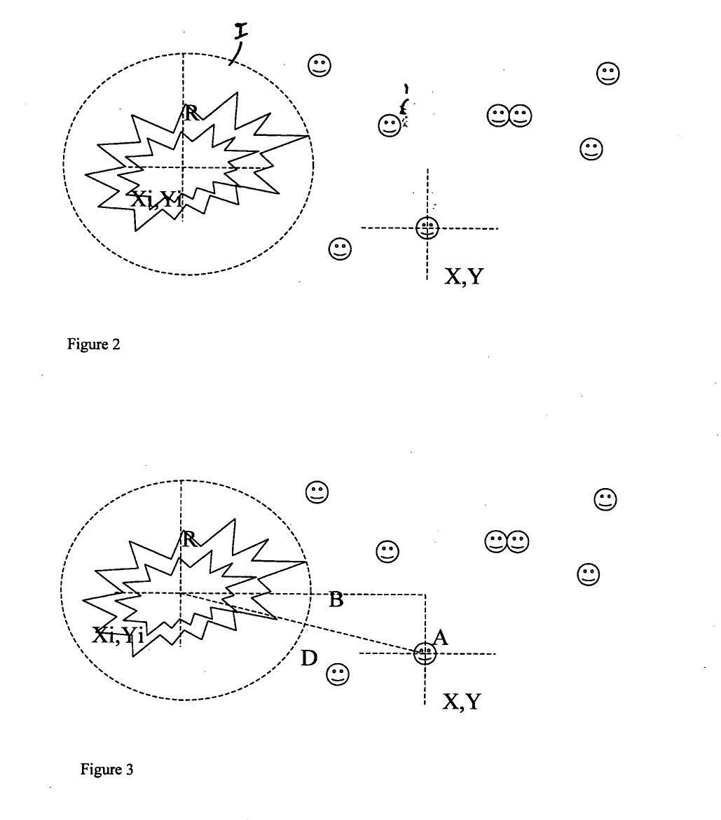

An embodiment using mobile phones, cell phone location via registered cell, and SMS messaging to contact people is shown in FIG. 1.

A number of mobile terminals (shown in the figure as cell phones 2) are connected to a telecommunications network via one or more cell towers. In the example shown, the first cell phone 1a is connected through a first base station (cell tower) 3a to a service provider 4. Two further cells phones 1b and 1c are connected through a second base station 3b to the service provider 4. Cell phone 1c in this instance also is equipped with a GPS system 10 enabling its position to be tracked by using the GPS satellite system 11 for more accurate positioning. The mobile telephone communications network 4 is connected to an incident centre 5 over SMS (text) gateway 2 and an LBS (location base service) gateway 5. The service centre 6 includes an incident management and customer service unit 7, a customer database 8, customer status tracking module 9, messaging and group module 10 and a location tracking module 11. This is connected via the SMS gateway and LBS gateway to the telecommunications network via firewalls 12.

The SMS messaging gateway 2 is used to send and receive messages. A desiccated number (preferably a short code of 4 or 5 digits) is used to receive SMS (short message service) messages via the message gateway.

The LBS (location based service gateway 5) is used to estimate a person's location. The LBS in this realisation is based on the location of the cell that the cell phone is currently registered to. Cell size effects the accuracy which can be down to 500 m in a city centre or as much as 25 k in a rural location. The accuracy is also returned by the LBS gateway. The diagram also show that some devices can used GPS or assisted GPS to determine their positions more precisely.

Operation of the product is described below using the mobile phone as the interface for all interaction. All operations would also be available via a Web interface and IVR or possibly a customer service agent.

Firstly, a user registers as a new user of the product. A person SMSs their name to the short code. They are then welcomed to the system and asked to SMS in phone numbers of friends and family.

Consent to Join a Users Group

Each number SMSed in is then sent a text message. If they are not users they are first prompted to register by SMSing their name to the short code. When they are registered they are prompted to respond with “YES” and a optional 4 digit security code to consent joining the group. The request is reciprocal as the sender is also joined to the receivers group. The security code is used to determine which message a reply is answering when there are multiple out standing requests request received.

The database 8 is used to store the registrations and grouping information for each user.

When an incident occurs, information about the incident is entered either automatically via data feeds and or alert services or manually by operations staff. The incident information is also updated at regular intervals as new information becomes available. The incident may, for example, be a bomb or other terrorist incident, a natural disaster, major fire or any other incident likely to affect an area of any size and where persons are likely to be concerned for the well-being of other persons in the vicinity.

When an incident occurs all users are optionally sent a SMS message with information about the incident asking them to respond with information on whether they were involved in the incident. Their status is updated depending on their reply.

Either all or only users who do not respond quickly have their location determined using the LBS gateway and this is compared to the location of the incident using the accuracy data, time date and the distance they could have travelled during this time. Their status is determined.

Regular status update messages are sent to users informing them of the status of the incident and their group members.

A user may send commands to the product at any time via the web, phone, SMS message or MMS message. Examples of main commands are listed below.

| Command | Notes |
|---|---|
| First name | registers the sender as a new customer |
| last name | |
| NNNNNNN | asks this phone for consent to join your group |
| Help | send a list of these commands |
| Help command | send help on one of these commands |
| Who | list all the people who can locate you (name and number) |
| Group | list all the people you can locate (name and number) |
| Stop | suspends the user from the service |
| Stop | removes this number from your group |
| NNNNNNN | |

Preferably, the service commands can be listed by sending the word “help”. Also requesting some one to join or leave your group is reciprocal so you are also removed or added to their group.

Service calls may be charged for by any existing billing service for example premium SMS, credit card or bank transfer.

In one embodiment, they are billed via PSMS (premium SMS). Each user is billed when they sign up and each month by premium SMS text message.

An example message detailed below.

Note: Some of the text messages may be over 160 characters and will require the sending of “long text messages”; this is two messages that are automatically re-combined on the phone into one message.

Registration

1. Unregistered customer text's in their name to the short code
“John Smith” to short code
2. Their cell phone company forwards the text message via the SMS gateway to the application servers. The message, network, and the phone number are used to create a new customer in the user database
3. The system sends a confirmation premium SMS text messages via the SMS gateway welcoming them to the product.
   “Welcome. Please text in all the mobile phone numbers you would like us to locate in the event of an emergency, send them to SHORT CODE separated by spaces. Or send HELP”
   Adding a Mobile to be Monitored
1. When the product receives any text messages sent to the SHORT CODE from a phone number that is in the customer table with status registered, the system decodes it and finds all the mobile numbers in the message.
2. If no mobile number is found then reply with this help message for example “You are registered to locate X mobile phones in the event of emergencies. You are also being monitored by X people. Text in more phone numbers you would like us to locate to SHORT CODE”.

Where X is the number of people who you are monitoring and are also monitoring you in the event of an emergency incident.
3. For each mobile number the system creates a record in the Monitoring database table with the phone number of the person tracking them and the phone number of the person being tracked its status is set to unconfirmed. The system then checks if they are already registered.
   Already Registered then step 4
4. The system sends them this text message: (note that the reply by 123 is dynamic and allows someone to have a number of outstanding request to be added to peoples tracking groups)
   “John Smith (0777987653) has asked us to locate your mobile phone in the event of an emergency. Reply to SHORT CODE with 1234 to accept or NO to decline.”

Where 1234 is an optional pin to differentiate between multiple requests.

New customer then step 5.
5. The system sends them this text message:
   “John Smith (0777987653) has asked us to locate your mobile phone in the event an emergency. It cost you X $ or £ per month for us to track your phones location. text your name to SHORT CODE to register then text “YES 1234″ to accept or NO to decline”.
   Accepting a Monitoring Request
1. When a text message starting with “NNN” or “no” is received. The system finds the customer data and the monitor data from the database.

If NNN is found in then step 2.
2. The system sets the monitoring recorded to active and the following message is sent.
   “The phone number (0773623723) accepted your monitoring request and their phone will be located in the event of an emergency.”

If “NO” then step 3
3. The system sets the monitoring recorded to declined and the following message is sent.
   “The phone number (0773623723) declined your monitoring request.”
   Billing for the PSMS Realisation of the Product
1. Every day the system queries the database for all people who have a last billed date of over one month ago. They are each send a X $ or £ premium message and their last billed date is then set to today.
   “Monthly reminder that XYZ inc is monitoring X mobile phone numbers for you. They will be located in the event of an emergency. Text STOP to cancel”

If the billing system detects a current incident in the incident table billing is delayed for 2 days.

The billing system includes a method of reconciliation of billed messages to PSMS delivery reports with a 3 day re-bill wait if a billing fail occurs

Emergency Incident Procedures

1. When an emergency incident occurs the system operator enters the time, a description, a map reference and the radius of the incident. This is entered in to the administration web site. This site has strong authentication. The system can run multiple incidents at multiple locations.
2. An incident message is sent to all customers.
   “An incident of type XXXXXX happened today at XX:XXpm/am located at YYYYYYYYY. We are currently locating/contacting the mobile phone of all people in your group and will send you their status shortly”
3. All mobile terminals in the system are then located and their distance to the incident is calculated. Any within the radius (+accuracy of the location request) are set to the status of unconfirmed and are sent an ‘are you OK’ text message
   “Your mobile has been identified as being near the incident. Please reply to [SHORT CODE] with “I AM OK” or if you have a problem a message that describes your ‘situation’
4. All others (out of this radius) are automatically set to a status of OK.
5. After the locations and status of all users have been determined a status message is sent to all group owners. If a status cannot be determined within X mins then they are assigned a status of unknown.
   “We have located the mobile phones of all XX people in your group and they are all well out side the area of the incident”
   or
   “We have located the mobile phones of all XX people in your group, YY are well out side the area of the incident and ZZ are near the incident but have confirmed to us by text message that the are OK”
   or
   “YY are outside the area of the incident and ZZ are near but have confirmed to us by text message that the are ok, NN currently are near and have not yet responded to our message”
6. When some one responds with OK the status is changed to OK and a message is sent to everyone who is monitoring them.
   “We have just received a message from NNNNNNNN at NN: NN that they are OK”

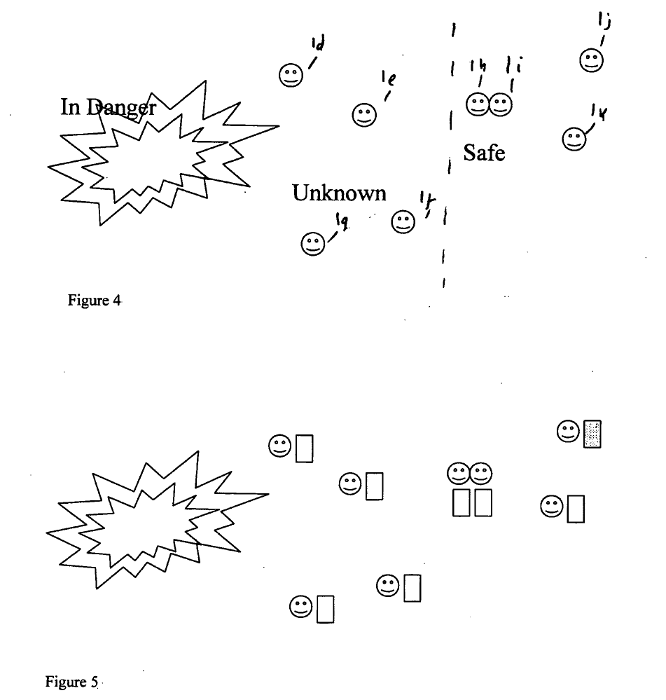

FIGS. 4 shows the status ‘unknown’ allocated to some users 1d-1g, and status ‘safe’ allocated to users 1h-1k.

FIG. 5 shows messages sent to the various users.

Note that in some embodiments some or all of the contacts to whom messages are sent need not be registered customers and need not have their specific location monitored. They can simply be stored as telephone numbers and the monitored subscriber is charged for the messages to them indicative of his status in an incident.

1. A method of determining the status of holders of mobile communications terminals during an incident, comprising determining the location of an incident; determining the position of the mobile terminal and using the position of the mobile terminal relative to the incident to determine the state of the user of that terminal, and using that status to transmit a message concerning the user's status to one or more selected contacts of that user.

2. A method as claimed in claim 1, including a step of determining whether the terminal is within a predetermined distance from the epicentre of the incident or of the incident or not and sending an appropriate status message to the one or more contacts accordingly.

3. A method as claimed in claim 1 or 2 and if the terminal is within a predetermined distance from the incident, including the step of transmitting a message to the terminal requesting a response so that the status transmitted can be based upon this response.

4. A method as claimed in claim 1, wherein a plurality of terminals are monitored, the terminals being grouped and status messages are transmitted to all or selected terminals in a group, representative of the status of one or more other terminals in said group.

5. A system for locating the user of a mobile terminal in the event of an incident and alerting one or more predetermined contacts, the system comprising, in the event of a particular incident, determining the position of the mobile terminal and its relative distance from the incident or the epicentre of an incident, and means for using this position to transmit status messages to one or more predetermined contacts.

6. A system as claimed in claim 5, comprising means for determining whether the terminal is within a predetermined distance from the incident or incident epicentre and, if so, for transmitting a message to the terminal requiring a response so that the presence or absence of a response determines the status transmitted to said one or more contacts.

7. A system as claimed in claim 5 or 6, comprising means for determining whether the terminal is greater than a predetermined distance from the incident or epicentre and, if so, for transmitting a signal to one or more contacts regarding the status of the terminal user.

8. A system as claimed in claim 5, including a plurality of monitored terminals, the terminals being grouped and wherein status messages are transmitted to terminals in a group, representative of the status of one or more other terminals in said group.

9. A system as claimed in claim 6 or 7, wherein a control centre having means for determining the location of an incident.

10. A system as claimed in claim 9, wherein the control centre includes means for receiving details of the incident from a third party.

11. A system as claimed in claim 9, including a location means for providing an indication of the location of the or each monitored terminal to the control centre at the time of the incident.

12. A system as claimed in claim 11, wherein cell-based location is used to determine the location of the or each terminal.

13. A system as claimed in claim 11, wherein GPS or other satellite-based location system is at least partly used to determine the location of the or each terminal.

14. A system as claimed in claim 5, including means for determining the relative distance of the or each monitored terminal from a comparison of the location of the incident and of the location of each terminal, and for determining from the or each terminal, dependent upon the relative distance, whether to request status information from that terminal or not.

15. A system as claimed in claim 5, wherein the messages are sent using SMS, email or other messaging protocol.

16. A system substantially as hereinbefore described with reference to, and as illustrated by, the accompanying drawings.

17. A method substantially as hereinbefore described with reference to the accompanying drawings.
